(19) United States
(12) Patent Application Publication
(10) Pub. No.: US 2020/0174308 A1
(43) Pub. Date: Jun. 4, 2020

(54) DISPLAY DEVICE

(71) Applicant: Samsung Display Co., Ltd., Yongin-si (KR)

(72) Inventors: Yongjun LEE, Hwaseong-si (KR); Jinsoo SHIN, Suwon-si (KR); Mansoo KIM, Asan-si (KR)

(21) Appl. No.: 16/690,597

(22) Filed: Nov. 21, 2019

(30) Foreign Application Priority Data
Nov. 29, 2018 (KR) 10-2018-0151072

(51) Int. Cl. G02F 1/1335

(52) U.S. Cl. CPC G02F 1/133504; G02F 1/133553; G02F 2001/1351; G02F 1/133606; G02F 1/133514; G02F 1/133605

(57) ABSTRACT

A display device includes a display panel, a backlight unit to provide a light to the display panel, a reflective member, and a light blocking member. The backlight unit includes a light guide member and a light source to provide the light to one side portion of the light guide member. The reflective member is disposed on the other side portion of the light guide member. The light blocking member covers the reflective member and at least a portion of corners of the light guide member.

### CROSS-REFERENCE TO RELATED APPLICATION

This application claims priority to and the benefit of Korean Patent Application No. 10-2018-0151072, filed on Nov. 29, 2018, the content of which is hereby incorporated by reference in its entirety.

### BACKGROUND

### 1. Field

The present disclosure relates to a liquid crystal display device. More particularly, the present disclosure relates to a liquid crystal display device having a narrow bezel.

### 2. Description of the Related Art

A display device has been used in various information processing devices, such as a television set, a monitor, a notebook computer, and a mobile phone, to display an image. A liquid crystal display device that includes a liquid crystal display panel including a liquid crystal layer and a backlight unit providing a light to the liquid crystal display panel has been developed to implement a display device that needs to be driven for a long time or has a large area.

In addition, a liquid crystal display device having a narrow bezel has been developed to provide a display device having high quality aesthetic characteristics.

As described above, when the bezel becomes thin, there may occur a light leakage phenomenon in which the light emitted from the backlight unit is directly perceived at a side surface of the liquid crystal display.

### SUMMARY

Aspects of embodiments of the present disclosure are directed toward a liquid crystal display device capable of reducing or preventing a light leakage phenomenon from occurring in a side surface thereof.

Embodiments of the inventive concept provide a display device including a display panel including a liquid crystal layer; a light guide member disposed under the display panel and including an upper surface, a lower surface, and a plurality of side surfaces; a light source to provide a blue light to a first side surface among the side surfaces of the light guide member; a reflective member disposed on a second side surface among the side surfaces of the light guide member; a wavelength conversion member disposed on the upper surface of the light guide member and including a quantum dot; and a light blocking member including a first portion that covers the reflective member and a second portion that extends from the first portion and overlaps with a portion of the wavelength conversion member, which is adjacent to the reflective member.

The display device further includes a lenticular film disposed on the lower surface of the light guide member.

The light blocking member further includes a third portion disposed under a portion of the lenticular film, which is adjacent to the reflective member.

The display device further includes a support member disposed under the lenticular film and a reflective sheet disposed between the support member and the lenticular film.

The support member includes a first support member supporting the reflective sheet and a second support member extending from the first support member, being parallel to the first portion of the light blocking member, and disposed adjacent to the second side surface of the light guide member.

The display device further includes an optical sheet disposed between the display panel and the wavelength conversion member. The optical sheet is a diffuser, a horizontal prism sheet, a vertical prism sheet, or a brightness improvement film.

The display device further includes a first adhesive member overlapping with the first portion of the light blocking member, not overlapping with the optical sheet, and coupling the first portion of the light blocking member to the display panel and a second adhesive member overlapping with the third portion of the light blocking member, not overlapping with the reflective sheet, and coupling the third portion of the light blocking member to the support member.

The reflective member includes silver (Ag).

The light guide member includes a glass material.

Embodiments of the inventive concept provide a display device including a display panel including a liquid crystal layer, a light guide member disposed under the display panel and including an upper surface, a lower surface substantially parallel to the upper surface, and a plurality of side surfaces connecting the upper surface and the lower surface, a light source to provide a light having a first wavelength to a first side surface among the side surfaces of the light guide member, a reflective member disposed on a second side surface among the side surfaces of the light guide member, a wavelength conversion member disposed on the upper surface to convert at least a portion of the light to a light having a second or third wavelength different from the first wavelength, and a light blocking member including a first portion that covers the reflective member and a second portion that extends from the first portion and overlaps with a portion of the wavelength conversion member, which is adjacent to the reflective member.

The first wavelength is shorter (smaller) than the second and third wavelengths.

According to one or more embodiments of the above, the light leakage phenomenon may be reduced or prevented from occurring in the side surface of the liquid crystal display device.

In addition, the liquid crystal display device may have a narrow bezel.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a plan view showing a display device according to an exemplary embodiment of the present disclosure;

FIG. 2 is a block diagram showing a display device according to an exemplary embodiment of the present disclosure;

FIG. 3 is an equivalent circuit diagram showing a pixel according to an exemplary embodiment of the present disclosure;

FIG. 4 is a cross-sectional view showing a pixel according to an exemplary embodiment of the present disclosure;

FIG. 5 is a cross-sectional view taken along a line I-I′ of FIG. 1;

FIG. 6 is an enlarged cross-sectional view showing an example of an area AA of FIG. 5; and

FIGS. 7, 8, and 9 are cross-sectional views showing other examples of the area AA of FIG. 5.

### DETAILED DESCRIPTION

Hereinafter, the present invention will be explained in more detail with reference to the accompanying drawings.

In the drawings, the thickness of layers, films, and regions are exaggerated for clarity. As used herein, the term “and/or” includes any and all combinations of one or more of the associated listed items.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

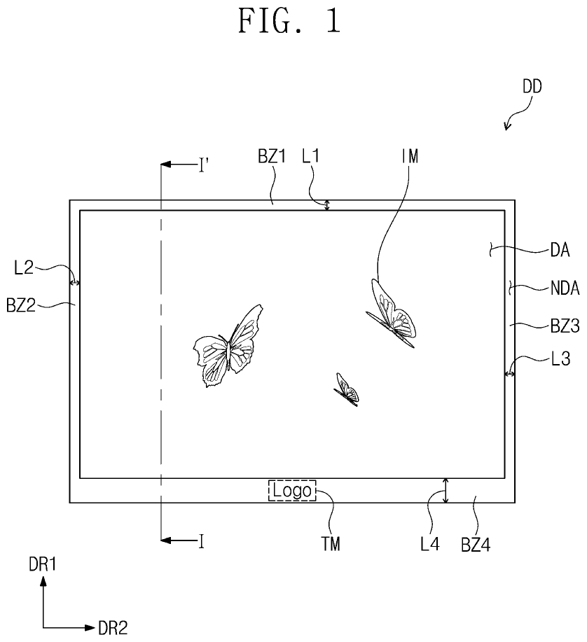

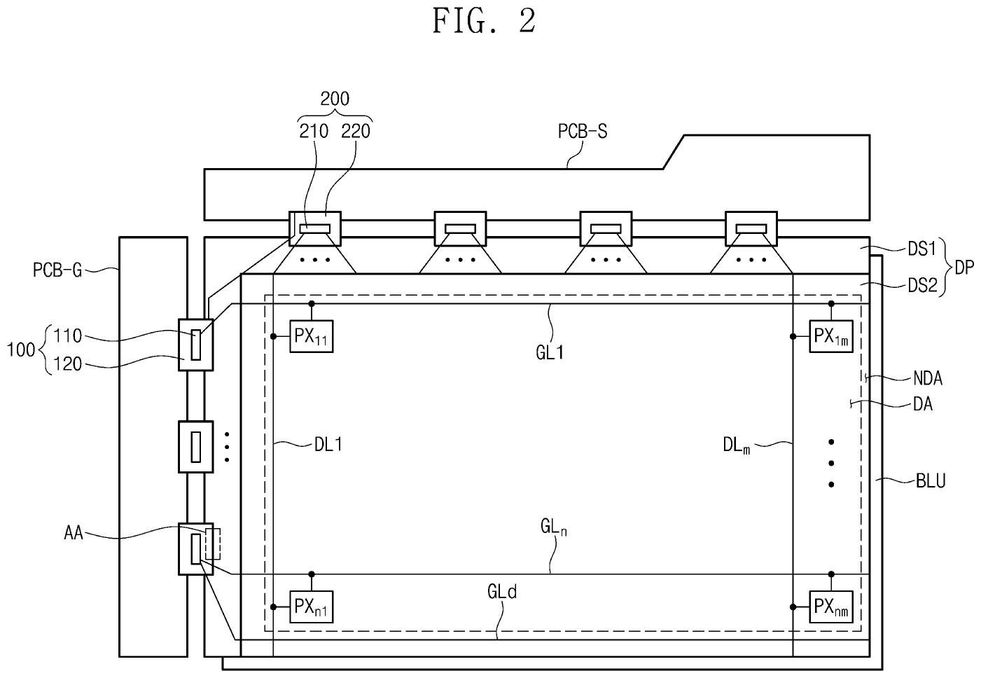

FIG. 1 is a plan view showing a display device DD according to an exemplary embodiment of the present disclosure. FIG. 2 is a block diagram showing the display device DD according to an exemplary embodiment of the present disclosure.

Referring to FIGS. 1 and 2, the display device DD includes a housing HS, a display panel DP, a gate driving circuit 100, a data driving circuit 200, and a backlight unit BLU.

As shown in FIG. 1, the display device DD includes a display area DA and a non-display area NDA. The display area DA is provided on a plane surface substantially parallel to a plane surface defined by a first direction DR1 and a second direction DR2 perpendicular to the first direction DR1. The non-display area NDA may be defined by the housing HS.

The housing HS includes a first bezel BZ1, a second bezel BZ2, a third bezel BZ3, and a fourth bezel BZ4, which define the non-display area NDA.

The first bezel BZ1 corresponds to an upper portion of the display device DD, the second bezel BZ2 corresponds to a left portion of the display device DD, the third bezel BZ3 corresponds to a right portion of the display device DD, and the fourth bezel BZ4 corresponds to a lower portion of the display device DD.

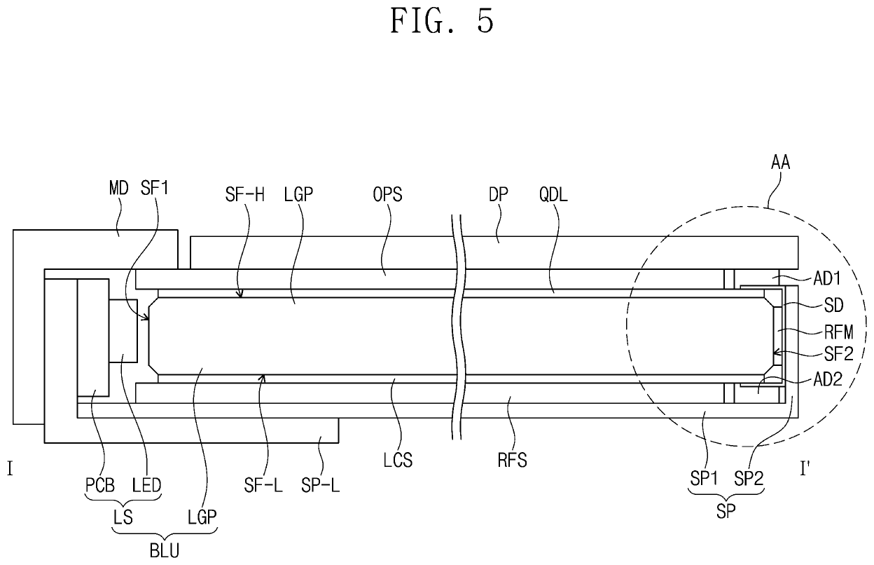

A light source LS (refer to FIG. 5) of the backlight unit BLU may be disposed in the fourth bezel BZ4. Accordingly, the fourth bezel BZ4 has a thickness L4 (hereinafter, referred to as a “fourth thickness”) greater than each of a thickness L1 (hereinafter, referred to as a “first thickness”) of the first bezel BZ1, a thickness L2 (hereinafter, referred to as a “second thickness”) of the second bezel BZ2, and a thickness L3 (hereinafter, referred to as a “third thickness”) of the third bezel BZ3.

Since the fourth thickness L4 is greater than each of the first, second, and third thicknesses L1, L2, and L3, a logo TM (or a trademark) representing a manufacturer of the display device DD may be marked in and/or on the fourth bezel BZ4.

The display area DA provides a user with information about image IM. FIG. 1 shows a butterfly as a representative example of the image IM.

The housing HS protects the display panel DP from external impacts or contaminants.

The display panel DP displays an image. The display panel DP according to the present exemplary embodiment should not be particularly limited and may include a non-light emitting type display panel that requires a separate light source, i.e., a reflective/transmissive type display panel or a transmissive type display panel. Hereinafter, a liquid crystal display panel will be described as the display panel DP.

The display panel DP includes a first substrate DS1, a second substrate DS2 facing the first substrate DS1, and a liquid crystal layer LCL (refer to FIG. 4) disposed between the first substrate DS1 and the second substrate DS2. The liquid crystal layer includes a plurality of liquid crystal molecules whose alignment is varied depending on an electric field formed between the first substrate DS1 and the second substrate DS2. The first substrate DS1 and the second substrate DS2 may include a glass material.

In one or more embodiments, polarizers may be respectively disposed on and under the display panel DP. In FIGS. 1 and 2, the display panel DP has a flat shape, however, it should not be limited thereto or thereby. That is, the display panel DP may have a curved shape with a set or predetermined curvature according to another embodiment.

The backlight unit BLU may provide the light to the display panel DP.

When viewed in a plan view, the display panel DP includes the display area DA in which a plurality of pixels PX11 to PXnm is arranged and the non-display area NDA surrounding the display area DA.

The display panel DP includes a plurality of gate lines GL1 to GLn disposed on the first substrate DS1 and a plurality of data lines DL1 to DLm crossing the gate lines GL1 to GLn. The gate lines GL1 to GLn are connected to the gate driving circuit 100. The data lines DL1 to DLm are connected to the data driving circuit 200. FIG. 2 shows some gate lines among the gate lines GL1 to GLn and some data lines among the data lines DL1 to DLm. In addition, the display panel DP may further include a dummy gate line GLd.

FIG. 2 shows some pixels among the pixels PX11 to PXnm. Each of the pixels PX11 to PXnm is connected to a corresponding gate line among the gate lines GL1 to GLn and a corresponding data line among the data lines DL1 to DLm. However, the dummy gate line GLd is not connected to the pixels PX11 to PXnm.

The pixels PX11 to PXnm may be divided into a plurality of groups depending on colors displayed therethrough. The pixels PX11 to PXnm display one of primary colors, such as the primary colors of red, green, blue, and/or white. The primary colors may further include various other colors, such as yellow, cyan, and/or magenta.

The gate driving circuit 100 and the data driving circuit 200 receive a control signal from a signal controller, e.g., a timing controller. The gate driving circuit 100 includes a first driving chip 110 and a first flexible printed circuit board 120. The data driving circuit 200 includes a second driving chip 210 and a second flexible printed circuit board 220.

The signal controller is mounted on a source circuit board PCB-S. The signal controller receives image data and control signals from an external graphic controller. The control signals include a vertical synchronization signal as a frame distinction signal to distinct frame periods, a horizontal synchronization signal as a row distinction signal to distinct horizontal periods, and a data enable signal maintained at a high level during a period, in which data are output, to indicate a data input period.

The gate driving circuit 100 generates gate signals in response to a control signal (hereinafter, referred to as a “gate control signal”) provided from the signal controller during frame periods and outputs the gate signals to the gate lines GL1 to GLn. The gate signals are sequentially output to correspond to the horizontal periods.

FIG. 2 shows one gate driving circuit 100 connected to left ends of the gate lines GL1 to GLn. In the exemplary embodiment of the present disclosure, a tape carrier package (TCP) type gate driving circuit 100 by a gate circuit board PCB-G is shown as a representative example, however, it should not be limited thereto or thereby. According to another embodiment of the present disclosure, the gate driving circuit 100 may be concurrently or substantially simultaneously formed with the pixels PX11 to PXnm through a thin film process. For instance, the gate driving circuit 100 may be implemented in the non-display area NDA in an amorphous silicon TFT gate driver circuit (ASG) form or an oxide semiconductor TFT gate driver circuit (OSG) form.

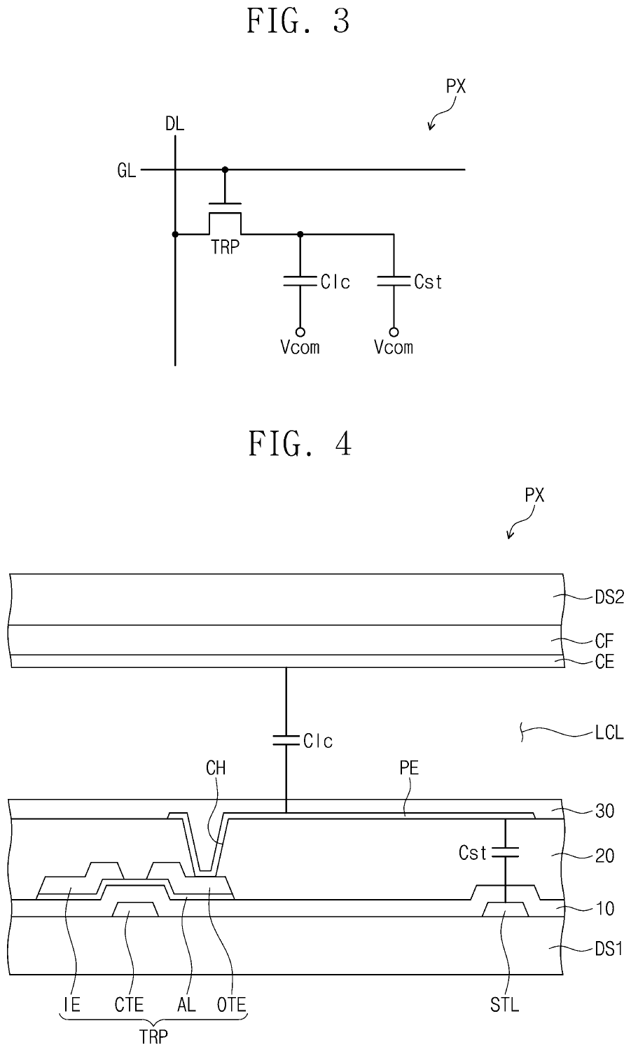

FIG. 3 is an equivalent circuit diagram showing a pixel PX according to an exemplary embodiment of the present disclosure. FIG. 4 is a cross-sectional view showing the pixel PX according to an exemplary embodiment of the present disclosure.

Referring to FIG. 3, the pixel PX includes a pixel thin film transistor TRP (hereinafter, referred to as a “pixel transistor”), a liquid crystal capacitor Clc, and a storage capacitor Cst.

Hereinafter, the term “transistor” may indicate a thin film transistor in the present disclosure. In the exemplary embodiment of the present disclosure, the storage capacitor Cst may be omitted.

FIGS. 3 and 4 show the pixel transistor TRP electrically connected to the gate line GL and the data line DL.

The pixel transistor TRP outputs a pixel voltage corresponding to the data signal applied thereto through the data line DL in response to the gate signal applied thereto through the gate line GL.

The liquid crystal capacitor Clc is charged with the pixel voltage output from the pixel transistor TRP. The alignment of liquid crystal directors included in the liquid crystal layer LCL (refer to FIG. 4) is varied depending on a charge amount charged in the liquid crystal capacitor Clc. The light incident upon and into the liquid crystal layer is transmitted or blocked by the alignment of the liquid crystal directors.

The storage capacitor Cst is connected to the liquid crystal capacitor Clc in parallel. The storage capacitor Cst allows the alignment of the liquid crystal directors to be maintained during a set or predetermined period.

As shown in FIG. 4, the pixel transistor TRP includes a control electrode CTE connected to the gate line GL, an active layer AL overlapped with the control electrode CTE, an input electrode IE connected to the data line DL, and an output electrode OTE disposed spaced apart from the input electrode IE.

The liquid crystal capacitor Clc includes a pixel electrode PE and a common electrode CE. The storage capacitor Cst includes a pixel electrode PE and a portion of a storage line STL overlapped with the pixel electrode PE. A common voltage Vcom is applied to the common electrode CE, and the data signal is applied to the pixel electrode PE.

The gate line GL and the storage line STL are disposed on one surface of the first substrate DS1. The control electrode CTE is branched from the gate line GL.

The gate line GL and the storage line STL include a metal material, such as aluminum (Al), silver (Ag), copper (Cu), molybdenum (Mo), chromium (Cr), tantalum (Ta), titanium (Ti), or an alloy thereof. The gate line GL and the storage line STL have a multi-layer structure of a titanium layer and a copper layer.

A first insulating layer 10 is disposed on the one surface of the first substrate DS1 to cover the control electrode CTE and the storage line STL. The first insulating layer 10 includes at least one selected from an inorganic material and an organic material. The first insulating layer 10 has a multi-layer structure of a silicon nitride layer and a silicon oxide layer.

The active layer AL is disposed on the first insulating layer 10 to overlap with the control electrode CTE. The active layer AL includes a semiconductor layer and an ohmic contact layer.

The active layer AL may include amorphous silicon or polysilicon. In addition, the active layer AL may include a metal oxide semiconductor.

The output electrode OTE and the input electrode IE are disposed on the active layer AL. The output electrode OTE and the input electrode IE are disposed to be spaced apart from each other. Each of the output electrode OTE and the input electrode IE partially overlaps with the control electrode CTE (e.g., overlaps in the thickness direction of the pixel PX).

FIG. 4 shows the pixel transistor TRP having a staggered structure as a representative example, however, the structure of the pixel transistor TRP should not be limited to the staggered structure. The pixel transistor TRP may have a planar structure.

A second insulating layer 20 is disposed on the first insulating layer 10 to cover the active layer AL, the output electrode OTE, and the input electrode IE. The second insulating layer 20 provides a flat surface. The second insulating layer 20 includes an organic material.

The pixel electrode PE is disposed on the second insulating layer 20. The pixel electrode PE is connected to the output electrode OTE via a contact hole CH defined through the second insulating layer 20. An alignment layer 30 is disposed on the second insulating layer 20 to cover the pixel electrode PE.

A color filter layer CF is disposed on one surface of the second substrate DS2. The common electrode CE is disposed on one surface of the color filter layer CF. The common voltage is applied to the common electrode CE. The common voltage has a different value from the pixel voltage. An alignment layer may be disposed on the one surface of the common electrode CE. Another insulating layer may be disposed between the color filter layer CF and the common electrode CE.

The pixel electrode PE and the common electrode CE form the liquid crystal capacitor Clc with the liquid crystal layer LCL interposed therebetween. In addition, the pixel electrode PE and the portion of the storage line STL form the storage capacitor Cst with the first and second insulating layers 10 and 20 interposed therebetween. The storage line STL receives a storage voltage having a different value from the pixel voltage. The storage voltage has the same value as the common voltage.

Meanwhile, the cross-section of the pixel PX shown in FIG. 4 is merely exemplary. Different from FIG. 4, at least one selected from the color filter layer CF and the common electrode CE may be disposed on the first substrate DS1. According to another embodiment of the present disclosure, the display panel may include a vertical alignment (VA) mode pixel, a patterned vertical alignment (PVA) mode pixel, an in-plane switching (IPS) mode pixel, a fringe-field switching (FFS) mode pixel, or a plane-to-line switching (PLS) mode pixel.

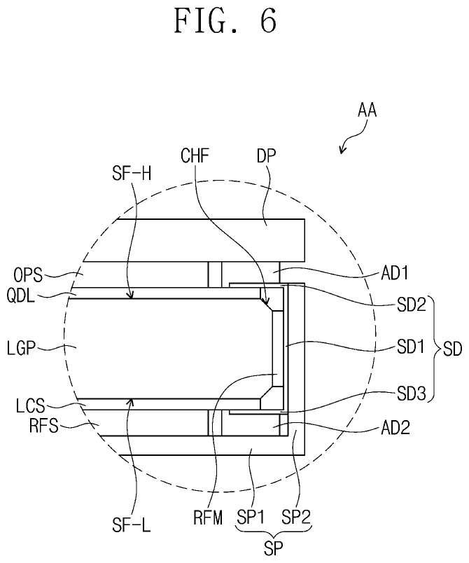

FIG. 5 is a cross-sectional view taken along a line I-I′ of FIG. 1. FIG. 6 is an enlarged cross-sectional view showing an example of an area AA of FIG. 5.

The backlight unit BLU is disposed under the display panel DP.

In the exemplary embodiment of the present disclosure, the backlight unit BLU includes a light guide member (e.g., a light guide or light guide panel) LGP and a light source LS.

The light guide member LGP guides the light provided from the light source LS and allows the light to travel to the display panel DP. The light guide member LGP has a transparent property. The light guide member LGP may include a glass material.

The light guide member LGP includes an upper surface SF-H, a lower surface SF-L, a first side surface SF1, and a second side surface SF2.

The upper surface SF-H and the lower surface SF-L face each other and are disposed to be parallel to each other.

The first side surface SF1 and the second side surface SF2 face each other. Each of the first side surface SF1 and the second side surface SF2 connects the upper surface SF-H and the lower surface SF-L.

In one or more embodiments, the light guide member LGP may further include a third side surface and a fourth side surface facing the third side surface, which connect the upper surface SF-H and the lower surface SF-L.

Among corners of the light guide member LGP, at least some corners may have a chamfered shape CHF. When the corners of the light guide member LGP have the chamfered shape CHF, a possibility in which some portions of the light guide member LGP are damaged due to external impacts may be lowered.

The light source LS provides the light to the first side surface SF1 of the light guide member LGP.

The light source LS includes a plurality of point light sources LED and a printed circuit board PCB.

Each of the point light sources LED includes a light emitting diode (LED) chip. The LED chip is mounted on the printed circuit board PCB and emits a light in a visible light region. In the exemplary embodiment of the present disclosure, the light emitted from the point light sources LED has a blue color.

A reflective member (e.g., a reflector) RFM is disposed on the second side surface SF2. The reflective member RFM reflects the light emitted from the light source LS to reduce the light that is lost on the side of the second side SF2. In the exemplary embodiment of the present disclosure, the reflective member RFM includes silver (Ag), however, it should not be limited thereto or thereby as long as the reflective member RFM includes a material that reflects the light incident thereupon.

A wavelength conversion member (e.g., a wavelength converter) QDL is mounted on the upper surface SF-H. The wavelength conversion member QDL converts a wavelength of the light generated by the light source LS and guided by the light guide member LGP. For example, when the light source LS generates the blue light having a first wavelength, the wavelength conversion member QDL converts a portion of the blue light to a green light having a second wavelength longer than the first wavelength or to a red light having a third wavelength longer than the second wavelength.

In the exemplary embodiment of the present disclosure, the wavelength conversion member QDL includes a quantum dot.

The quantum dot may be selected from Group II-VI compounds, Group III-V compounds, Group IV-VI compounds, Group IV elements, Group IV compounds, and combinations thereof.

The Group II-VI compounds may be selected from the groups consisting of divalent compounds selected from the group consisting of CdSe, CdTe, ZnS, ZnSe, ZnTe, ZnO, HgS, HgSe, HgTe, MgSe, MgS, and mixtures thereof, trivalent compounds selected from the group consisting of CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and mixtures thereof, and tetravalent compounds selected from the group consisting of HgZnTeS, CdZnSeS, CdZnSeTe, CdZnSTe, CdHgSeS, CdHgSeTe, CdHgSTe, HgZnSeS, HgZnSeTe, HgZnSTe, and mixtures thereof.

The Group III-V compounds may be selected from the groups consisting of divalent compounds selected from the group consisting of GaN, GaP, GaAs, GaSb, AIN, AIP, AlAs, AlSb, InN, InP, InAs, InSb, and mixtures thereof, trivalent compounds selected from the group consisting of GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and mixtures thereof, and tetravalent compounds selected from the group consisting of GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and mixtures thereof.

The Group IV-VI compounds may be selected from the groups consisting of divalent compounds selected from the group consisting of SnS, SnSe, SnTe, PbS, PbSe, PbTe, and mixtures thereof, trivalent compounds selected from the group consisting of SnSeS, SnSeTe, SnSTe, PbSeS, PbSeTe, PbSTe, SnPbS, SnPbSe, SnPbTe, and mixtures thereof, and tetravalent compounds selected from the group consisting of SnPbSSe, SnPbSeTe, SnPbSTe, and mixtures thereof.

The Group IV elements may be selected from the groups consisting of Si, Ge, and mixtures thereof. The Group IV compounds may be divalent compounds selected from the groups consisting of SiC, SiGe, and mixtures thereof. In this case, the divalent compounds, the trivalent compounds, and the tetravalent compounds may be present in particles at a uniform concentration, or may be present in the same particles by partially dividing a concentration distribution into different states.

The quantum dot has a core-shell structure including a core and a shell surrounding the core. In addition, the quantum dot may have a core-shell structure in which one quantum dot surrounds another quantum dot. An interface between the core and the shell may have a concentration gradient in which a concentration of elements present in the shell becomes lower toward a center of the core.

The quantum dot may be a particle having a nanometer-scale particle. The quantum dot has a full width of half maximum (FWHM) of a light emission wavelength spectrum equal to or smaller than about 45 nm, preferably about 40 nm, or more preferably about 30 nm, and may improve a color purity or a color reproducibility. In addition, since the light emitted through the quantum dot travels in all directions (360 degrees), a wide viewing angle may be improved.

In addition, the quantum dot has a spherical shape, a pyramid shape, a multi-arm shape, a cubic nanoparticle shape, a cubic nanotube shape, a cubic nanowire shape, a cubic nanofiber shape, or a cubic nanoplate particle shape, however, it should not be limited thereto or thereby.

The color of the light emitted from the quantum dot may be changed depending on a size of particles of the quantum dot. At least some quantum dots included in the wavelength conversion member QDL may have different sizes from each other.

An optical sheet OPS is disposed between the display panel DP and the wavelength conversion member QDL.

The optical sheet OPS includes at least one selected from a diffusion plate, a diffuser, a first prism sheet (e.g., horizontal prism sheet), a second prism sheet (e.g., a vertical prism sheet), and a brightness improvement member (e.g., a brightness improver).

A lenticular film LCS is disposed on the lower surface SF-L of the light guide member LGP.

The reflective sheet RFS is disposed under the lenticular film LCS. The reflective sheet RFS has a white color or a metal material to reflect the light.

The lenticular film LCS and the reflective sheet RFS reflect the light exiting from the backlight unit BLU to increase a light efficiency of the backlight unit BLU.

A light blocking member (e.g., a light blocker) SD covers one side portion of the reflective member RFM and the light guide member LGP to prevent the light exiting from the backlight unit BLU from leaking through the second side surface SF2. The light blocking member SD may be, for example, a tape having a black color.

In more detail, the light blocking member SD includes a first portion SD1, a second portion SD2 extending from the first portion SD1, and a third portion SD3 extending from the first portion SD1.

The first portion SD1 covers the reflective member RFM. The second portion SD2 overlaps with a portion of the wavelength conversion member QDL, which is adjacent to the reflective member RFM. The third portion SD3 overlaps with a portion of the lenticular film LCS, which is adjacent to the reflective member RFM.

FIGS. 5 and 6 show the embodiment in which a spacing defined by the chamfered shape CHF exists between the light blocking member SD and the light guide member LGP, however, it should not be limited thereto or thereby. According to another embodiment of the present disclosure, the light blocking member SD and the light guide member LGP may be in close or direct contact with each other.

A support member (e.g., a support) SP is disposed under the reflective sheet RFS. The support member SP has a rigidity to support components disposed thereon. The support member SP includes a synthetic resin and/or a metal material.

The support member SP includes a first support member SP1 and a second support member SP2.

The first support member SP1 is disposed adjacent to the lower surface SF-L of the light guide member LGP. In more detail, the first support member SP1 is disposed under the reflective sheet RFS to support the reflective sheet RFS, the lenticular film LCS, and/or the light guide member LGP.

The first support member SP1 is disposed adjacent to a second side surface SF2 of the light guide member LGP. In one or more embodiments, the first support member SP1 is disposed adjacent to third and fourth side surfaces of the light guide member LGP. In more detail, the second support member SP2 extends from the first support member SP1 and is disposed parallel or substantially parallel to the first portion SD1 of the light blocking member SD.

A light source support member (e.g., a light source support) SP-L (FIG. 5) is disposed under the support member SP to hold the light source LS. The light source LS is mounted on the light source support member SP-L to provide the light to the first side surface SF1 of the light guide member LGP.

A mold frame MD covers a portion of the optical sheet OPS, an upper portion of the light source LS, and one side portion of the light source support member SP-L. The mold frame MD supports some of the components of the display device DD. The mold frame MD reduces or prevents a portion of the light emitted from the light source LS from leaking.

A first adhesive member (e.g., a first adhesive) AD1 is disposed on the second portion SD2 of the light blocking member SD. The first adhesive member AD1 does not overlap with the optical sheet OPS. In the exemplary embodiment of the present disclosure, the first adhesive member AD1 covers the second portion SD2 and the wavelength conversion member QDL.

The first adhesive member AD1 couples the second portion SD2 of the light blocking member SD and the display panel DP.

A second adhesive member (e.g., a second adhesive) AD2 is disposed under the third portion SD3 of the light blocking member SD. The second adhesive member AD2 does not overlap with the reflective sheet RFS. In the exemplary embodiment of the present disclosure, the second adhesive member AD2 covers the third portion SD3 and a portion of the lenticular film LCS.

The second adhesive member AD2 couples the third portion SD3 of the light blocking member SD and the support member SP.

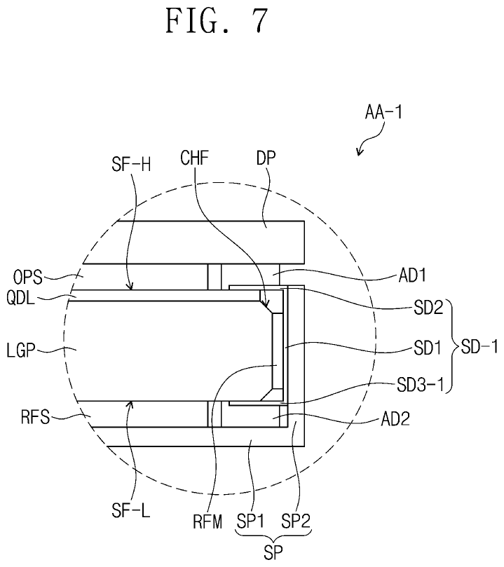

FIGS. 7, 8, and 9 are cross-sectional views showing other examples of the area AA of FIG. 5.

Referring to FIG. 7, a light blocking member SD-1 includes a first portion SD1, a second portion SD2, and a third portion SD3-1 in an area AA-1.

In the exemplary embodiment shown in FIG. 7, the lenticular film LCS is omitted compared with the embodiment shown in FIG. 6. Accordingly, different from the third portion SD3 shown in FIG. 6, the third portion SD3-1 shown in FIG. 7 may make contact with the lower surface SF-L of the light guide member LGP.

In addition, descriptions of other components shown in FIG. 7 are substantially the same as those of FIGS. 5 and 6, and thus details thereof will not be provided again.

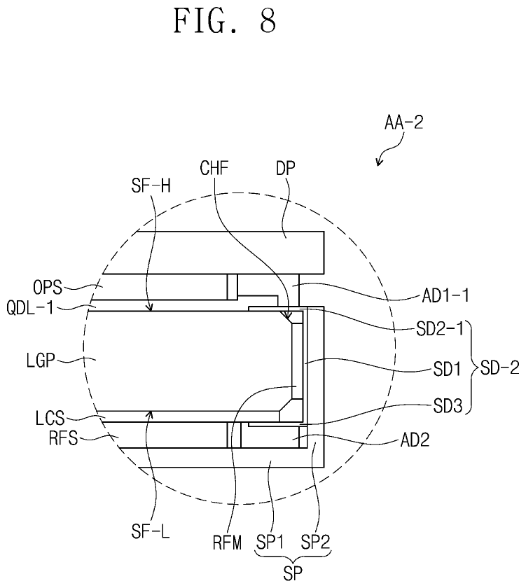

Referring to FIG. 8, a light blocking member SD-2 includes a first portion SD1, a second portion SD2-1, and a third portion SD3 in an area AA-2.

The second portion SD2-1 may make contact with the upper surface SF-H of the light guide member LGP. Accordingly, a portion of a wavelength conversion member QDL-1 may be disposed on the second portion SD2-1, and a first adhesive member AD1-1 may cover the portion of the wavelength conversion member QDL-1 and a portion of the second portion SD2-1.

In addition, descriptions of other components shown in FIG. 8 are substantially the same as those of FIGS. 5 and 6, and thus details thereof will not be provided again.

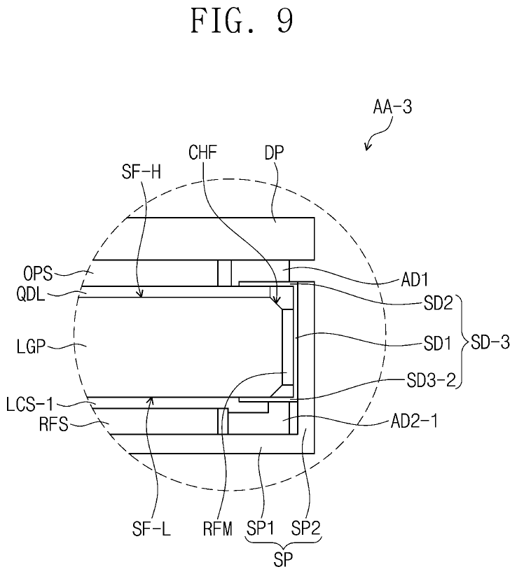

Referring to FIG. 9, a light blocking member SD-3 includes a first portion SD1, a second portion SD2-1, and a third portion SD3-2 in an area AA-3.

The third portion SD3-2 shown in FIG. 9 may make contact with the lower surface SF-L of the light guide member LGP. Accordingly, a portion of a lenticular film LCS-1 may be disposed under the third portion SD3-2, and a second adhesive member AD2-1 may cover the portion of the lenticular film LCS-1 and a portion of the third portion SD3-2.

In addition, descriptions of other components shown in FIG. 9 are substantially the same as those of FIGS. 5 and 6, and thus details thereof will not be provided again.

Spatially relative terms, such as “beneath”, “below”, “lower”, “under”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present. Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

As used herein, the terms “substantially”, “about”, and similar terms are used as terms of approximation and not as terms of degree, and are intended to account for the inherent deviations in measured or calculated values that would be recognized by those of ordinary skill in the art. Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Although the exemplary embodiments of the present disclosure have been described, it is understood that the present invention should not be limited to these exemplary embodiments, and that various suitable changes and modifications can be made by one of ordinary skill in the art within the spirit and scope of the present invention as hereinafter claimed. Therefore, the disclosed subject matter should not be limited to any single embodiment described herein, and the scope of the present inventive concept shall be determined according to the attached claims and equivalents thereof.

What is claimed is:

1. A display device comprising:
a display panel comprising a liquid crystal layer;
a light guide member under the display panel and comprising an upper surface, a lower surface, and a plurality of side surfaces;
a light source to provide a blue light to a first side surface among the side surfaces of the light guide member;
a reflective member on a second side surface among the side surfaces of the light guide member;
a wavelength conversion member on the upper surface of the light guide member and comprising a quantum dot; and
a light blocking member comprising a first portion that covers the reflective member and a second portion that extends from the first portion and overlaps with a portion of the wavelength conversion member, which is adjacent to the reflective member.

2. The display device of claim 1, further comprising a lenticular film on the lower surface of the light guide member.

3. The display device of claim 2, wherein the light blocking member further comprises a third portion under a portion of the lenticular film, which is adjacent to the reflective member.

4. The display device of claim 3, further comprising:
a support member under the lenticular film; and
a reflective sheet between the support member and the lenticular film.

5. The display device of claim 4, wherein the support member comprises:
a first support member supporting the reflective sheet; and
a second support member extending from the first support member, being substantially parallel to the first portion of the light blocking member, and adjacent to the second side surface of the light guide member.

6. The display device of claim 4, further comprising an optical sheet between the display panel and the wavelength conversion member.

7. The display device of claim 6, wherein the optical sheet is a diffuser, a horizontal prism sheet, a vertical prism sheet, or a brightness improvement film.

8. The display device of claim 6, further comprising:
a first adhesive member overlapping with the first portion of the light blocking member and not overlapping with the optical sheet, and coupling the first portion of the light blocking member to the display panel; and
a second adhesive member overlapping with the third portion of the light blocking member and not overlapping with the reflective sheet, and coupling the third portion of the light blocking member to the support member.

9. The display device of claim 1, wherein the reflective member comprises silver (Ag).

10. The display device of claim 1, wherein the light guide member comprises a glass material.

11. A display device comprising:
a display panel comprising a liquid crystal layer;
a light guide member under the display panel and comprising an upper surface, a lower surface substantially parallel to the upper surface, and a plurality of side surfaces connecting the upper surface and the lower surface;
a light source to provide a light having a first wavelength to a first side surface among the side surfaces of the light guide member;
a reflective member on a second side surface among the side surfaces of the light guide member;
a wavelength conversion member on the upper surface to convert at least a portion of the light to a light having a second or third wavelength different from the first wavelength; and
a light blocking member comprising a first portion that covers the reflective member and a second portion that extends from the first portion and overlaps with a portion of the wavelength conversion member, which is adjacent to the reflective member.

12. The display device of claim 11, wherein the first wavelength is shorter than the second and third wavelengths.

13. The display device of claim 12, further comprising a lenticular film on the lower surface of the light guide member.

14. The display device of claim 13, wherein the light blocking member further comprises a third portion under a portion of the lenticular film, which is adjacent to the reflective member.

15. The display device of claim 14, further comprising:
a support member under the lenticular film; and
a reflective sheet between the support member and the lenticular film.

16. The display device of claim 15, wherein the support member comprises:
a first support member supporting the reflective sheet; and
a second support member extending from the first support member, being substantially parallel to the first portion of the light blocking member, and adjacent to the second side surface of the light guide member.

17. The display device of claim 15, further comprising an optical sheet between the display panel and the wavelength conversion member.

18. The display device of claim 17, wherein the optical sheet is a diffuser, a horizontal prism sheet, a vertical prism sheet, or a brightness improvement film.

19. The display device of claim 17, further comprising:
a first adhesive member overlapping with the first portion of the light blocking member, not overlapping with the optical sheet, and coupling the first portion of the light blocking member to the display panel; and
a second adhesive member overlapping with the third portion of the light blocking member, not overlapping with the reflective sheet, and coupling the third portion of the light blocking member to the support member.

20. The display device of claim 11, wherein the reflective member comprises silver (Ag), and the light guide member comprises a glass material.
